(19) United States
(12) Patent Application Publication
(10) Pub. No.: US 2025/0210924 A1
(43) Pub. Date: Jun. 26, 2025

(54) LASER APPARATUS AND ELECTRONIC DEVICE MANUFACTURING METHOD

(71) Applicant: Gigaphoton Inc., Tochigi (JP)

(72) Inventor: Yousuke FUJIMAKI, Oyama-shi (JP)

(73) Assignee: Gigaphoton Inc., Tochigi (JP)

(21) Appl. No.: 18/945,005

(22) Filed: Nov. 12, 2024

(30) Foreign Application Priority Data
Dec. 26, 2023 (JP) 2023-219063

(51) Int. Cl. H01S 3/00; H01S 3/10; H01S 3/23

(52) U.S. Cl. CPC H01S 3/0057; H01S 3/10015; H01S 3/10084; H01S 3/2308

(57) ABSTRACT

A laser apparatus includes an oscillator configured to output seed light in a pulse form, a first amplifier configured to amplify the seed light and to output first amplified light, a first pulse stretcher configured to stretch a pulse width of the first amplified light, a beam splitter configured to split the first amplified light having a stretched pulse width into first split light and second split light having energy smaller than that of the first split light, a second amplifier configured to amplify a part of the second split light and to output second amplified light, a second pulse stretcher configured to stretch a pulse width of the second amplified light, and a beam combiner configured to combine the first split light and the second amplified light having a stretched pulse width to output combined light.

### CROSS-REFERENCE TO RELATED APPLICATIONS

The present application claims the benefit of Japanese Patent Application No. 2023-219063, filed on Dec. 26, 2023, the entire contents of which are hereby incorporated by reference.

### BACKGROUND

### 1. Technical Field

The present disclosure relates to a laser apparatus and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation beams of the KrF excimer laser apparatus and the ArF excimer laser apparatus are as wide as from 350 μm to 400 μm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: U.S. Patent Application Publication No. 2008/144671

### SUMMARY

A laser apparatus according to one aspect of the present disclosure includes an oscillator, a first amplifier, a first pulse stretcher, a beam splitter, a second amplifier, a second pulse stretcher, and a beam combiner. The oscillator is configured to output seed light in a pulse form. The first amplifier is configured to amplify the seed light and to output first amplified light. The first pulse stretcher is configured to stretch a pulse width of the first amplified light. The beam splitter is configured to split the first amplified light having a stretched pulse width into first split light and second split light having energy smaller than that of the first split light. The second amplifier is configured to amplify a part of the second split light and to output second amplified light. The second pulse stretcher is configured to stretch a pulse width of the second amplified light. The beam combiner is configured to combine the first split light and the second amplified light having a stretched pulse width to output combined light.

An electronic device manufacturing method according to one aspect of the present disclosure includes generating a laser beam with a laser apparatus, outputting the laser beam to an exposure apparatus, and exposing a photosensitive substrate to the laser beam within the exposure apparatus to manufacture an electronic device. The laser apparatus includes an oscillator configured to output seed light in a pulse form, a first amplifier configured to amplify the seed light and to output first amplified light, a first pulse stretcher configured to stretch a pulse width of the first amplified light, a beam splitter configured to split the first amplified light having a stretched pulse width into first split light and second split light having energy smaller than that of the first split light, a second amplifier configured to amplify a part of the second split light and to output second amplified light, a second pulse stretcher configured to stretch a pulse width of the second amplified light, and a beam combiner configured to combine the first split light and the second amplified light having a stretched pulse width to output combined light.

### BRIEF DESCRIPTION OF THE DRAWINGS

Some embodiments of the present disclosure will be described below, by way of example only, with reference to the accompanying drawings.

FIG. 1 illustrates a configuration of an exposure system in a comparative example.

FIG. 2 illustrates a configuration of a laser apparatus according to the comparative example.

FIG. 3 schematically illustrates a configuration of a laser apparatus according to a first embodiment.

FIG. 4 is a time chart illustrating pulse time waveforms of an oscillation trigger signal and a laser beam of respective parts of the laser apparatus according to the first embodiment.

FIG. 5 schematically illustrates a configuration of a laser apparatus according to a second embodiment.

FIG. 6 is a time chart illustrating pulse time waveforms of an oscillation trigger signal and a laser beam of respective parts of the laser apparatus according to the second embodiment.

FIG. 7 is a flowchart of control of an applied voltage executed by a processor in the first and second embodiments.

FIG. 8 illustrates a first configuration example of a beam combiner used in the first and second embodiments.

FIG. 9 illustrates a second configuration example of the beam combiner used in the first and second embodiments.

### DESCRIPTION OF EMBODIMENTS

### <Contents>

1. Comparative Example
   1.1 Configuration of Exposure Apparatus 200
   1.2 Operation of Exposure Apparatus 200
   1.3 Configuration of Laser Apparatus 100
      1.3.1 First and Second Oscillators MO1 and MO2
      1.3.2 First and Second Amplifiers PO1 and PO2
      1.3.3 First and Second Pulse Stretchers PS1 and PS2
      1.3.4 Others
   1.4 Operation of Laser Apparatus 100
      1.4.1 First and Second Oscillators MO1 and MO2
      1.4.2 First and Second Amplifiers PO1 and PO2
      1.4.3 First and Second Pulse Stretchers PS1 and PS2
      1.4.4 Others
   1.5 Problem of Comparative Example
2. Laser Apparatus 100a that Branches First Amplified Light Bpsa
   2.1 Configuration
   2.2 Operation
      2.2.1 Timing Control
      2.2.2 Energy Control
   2.3 Effect
3. Laser Apparatus 100b that Stretches Pulse Width of Combined Light Bpsa1+Bpsb
   3.1 Configuration
   3.2 Operation
   3.3 Effect
4. Others
   4.1 Control of Applied Voltage
   4.2 Configuration of Beam Combiner COM
   4.3 Supplements

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure.

Here, the same components are denoted by the same reference signs, and any redundant description thereof is omitted.

### 1. Comparative Example

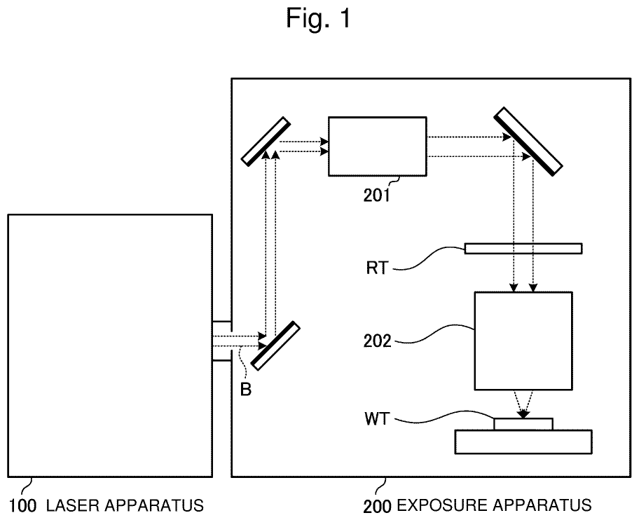

FIG. 1 illustrates a configuration of an exposure system in a comparative example. The comparative example of the present disclosure is an example recognized by the applicant as known only by the applicant, and is not a publicly known example admitted by the applicant.

The exposure system includes a laser apparatus 100 and an exposure apparatus 200. The laser apparatus 100 is configured to output a laser beam B toward the exposure apparatus 200.

### 1.1 Configuration of Exposure Apparatus 200

The exposure apparatus 200 includes an illumination optical system 201 and a projection optical system 202. The illumination optical system 201 illuminates a reticle pattern of an unillustrated reticle disposed on a reticle stage RT with the laser beam B that has entered from the laser apparatus 100. The projection optical system 202 performs reduced projection of the laser beam B transmitted through the reticle, and forms an image on an unillustrated workpiece disposed on a workpiece table WT. The workpiece is a photosensitive substrate such as a semiconductor wafer on which a resist film is applied.

### 1.2 Operation of Exposure Apparatus 200

The exposure apparatus 200 causes the reticle stage RT and the workpiece table WT to be translated in directions opposite to each other in synchronization. As a result, the workpiece is exposed by the laser beam B reflecting the reticle pattern. By such an exposure process, the reticle pattern is transferred onto the semiconductor wafer. Thereafter, an electronic device can be manufactured through a plurality of processes.

### 1.3 Configuration of Laser Apparatus 100

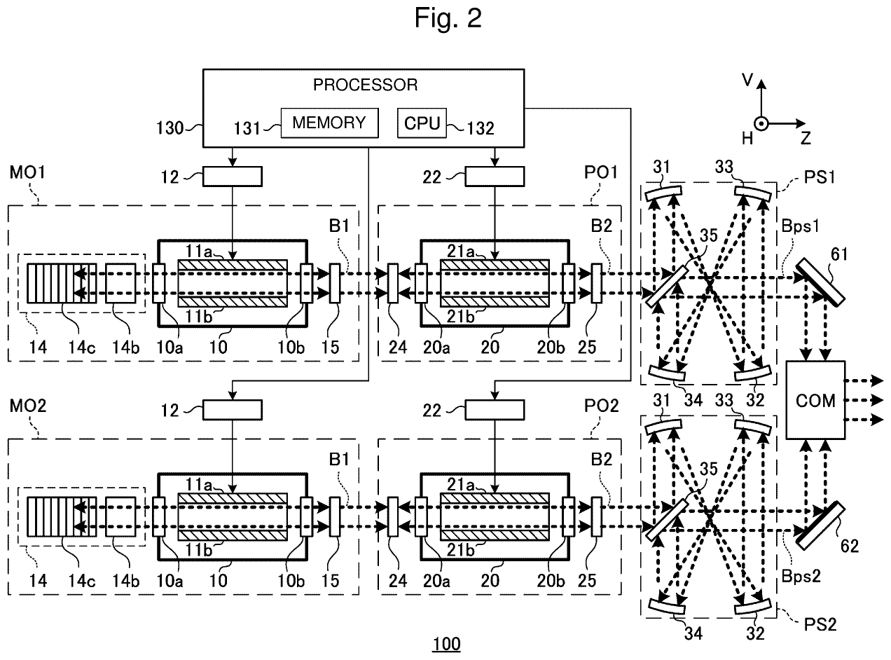

FIG. 2 illustrates a configuration of the laser apparatus 100 according to the comparative example. The laser apparatus 100 includes first and second oscillators MO1 and MO2, first and second amplifiers PO1 and PO2, first and second pulse stretchers PS1 and PS2, a beam combiner COM, and a processor 130.

### 1.3.1 First and Second Oscillators MO1 and MO2

The first and second oscillators MO1 and MO2 have the same configuration. Each of the first and second oscillators MO1 and MO2 is a master oscillator including a laser chamber 10, a pair of discharge electrodes 11a and l1b, a line narrowing module 14, and an output coupling mirror 15.

The line narrowing module 14 and the output coupling mirror 15 form a laser resonator. The laser chamber 10 is disposed in an optical path of the laser resonator. Windows 10a and 10b are provided on both ends of the laser chamber 10. The discharge electrodes 11a and l1b are disposed inside the laser chamber 10. A pulse power source 12 is connected to the discharge electrode 11a. The laser chamber 10 is filled with a laser gas containing, for example, an argon gas or a krypton gas as a rare gas, a fluorine gas as a halogen gas, and a neon gas as a buffer gas, or the like.

The line narrowing module 14 includes a prism 14b and a grating 14c. The prism 14b is disposed in an optical path of light output through the window 10a. The grating 14c is disposed in an optical path of light transmitted through the prism 14b. The output coupling mirror 15 is a partial reflective mirror, and is disposed in an optical path of light output through the window 10b.

### 1.3.2 First and Second Amplifiers PO1 and PO2

The first amplifier PO1 is disposed in an optical path of seed light B1 output from the first oscillator MO1, and the second amplifier PO2 is disposed in an optical path of the seed light B1 output from the second oscillator MO2. The first and second amplifiers PO1 and PO2 have the same configuration. Each of the first and second amplifiers PO1 and PO2 is a power oscillator including a laser chamber 20, a pair of discharge electrodes 21a and 21b, a rear mirror 24, and an output coupling mirror 25.

Each of the rear mirror 24 and the output coupling mirror 25 is a partial reflective mirror. A reflectance of the rear mirror 24 is set higher than a reflectance of the output coupling mirror 25. The rear mirror 24 and the output coupling mirror 25 form a laser resonator. The laser chamber 20 is disposed in an optical path of the laser resonator. Windows 20a and 20b are provided on both ends of the laser chamber 20. The discharge electrodes 21a and 21b are disposed inside the laser chamber 20. A pulse power source 22 is connected to the discharge electrode 21a. The laser chamber 20 is filled with a laser gas similar to that in the laser chamber 10.

A discharge direction between the discharge electrodes 11a and 11b and between the discharge electrodes 21a and 21b is defined as a V direction or a −V direction. An output direction of the seed light B1 through the output coupling mirror 15 is defined as a Z direction. The V direction and the Z direction are directions perpendicular to each other, and the directions perpendicular to both of them are an H direction and a −H direction.

### 1.3.3 First and Second Pulse Stretchers PS1 and PS2

The first pulse stretcher PS1 is disposed in an optical path of a laser beam B2 output from the first amplifier PO1, and the second pulse stretcher PS2 is disposed in an optical path of the laser beam B2 output from the second amplifier PO2. The first and second pulse stretchers PS1 and PS2 have the same configuration. Each of the first and second pulse stretchers PS1 and PS2 includes first to fourth concave mirrors 31-34 and a beam splitter 35. Each of the first to fourth concave mirrors 31-34 is a spherical mirror.

### 1.3.4 Others

High reflective mirrors 61 and 62 are disposed in optical paths of laser beams Bps1 and Bps2 output from the first and second pulse stretchers PS1 and PS2, respectively.

The beam combiner COM is disposed in a space including optical paths of both the laser beams Bps1 and Bps2 reflected by the high reflective mirrors 61 and 62, respectively.

The processor 130 is a processing device including a memory 131 in which a control program is stored, and a CPU (central processing unit) 132 which executes the control program. The processor 130 is specifically configured or programmed to execute various kinds of processes included in the present disclosure.

### 1.4 Operation of Laser Apparatus 100

### 1.4.1 First and Second Oscillators MO1 and MO2

In each of the first and second oscillators MO1 and MO2, when a high voltage pulse generated by the pulse power source 12 is applied to the discharge electrode 11a, discharge occurs inside the laser chamber 10. By energy of the discharge, a laser medium in the laser chamber 10 is excited and shifts to a high energy level. When the excited laser medium then shifts to a low energy level, light having a wavelength corresponding to the energy level difference is discharged. The light generated inside the laser chamber 10 is output to an outside of the laser chamber 10 through the windows 10a and 10b.

The light output through the window 10a of the laser chamber 10 is stretched in a beam width in the H direction by the prism 14b, and enters the grating 14c. The light that has entered the grating 14c from the prism 14b is reflected by a plurality of grooves of the grating 14c, and is also diffracted in a direction corresponding to the wavelength of the light. The prism 14b reduces the beam width in the H direction of diffracted light from the grating 14c and returns the light to the laser chamber 10 through the window 10a.

The output coupling mirror 15 transmits and outputs a part of the light output through the window 10b of the laser chamber 10, and reflects the other part back to the inside of the laser chamber 10 through the window 10b.

In this way, the light output from the laser chamber 10 reciprocates between the line narrowing module 14 and the output coupling mirror 15, and is amplified every time it passes through a discharge space inside the laser chamber 10. The light is line-narrowed every time it is turned back in the line narrowing module 14. The light laser-oscillated and band-narrowed in this way is output as the seed light B1 through the output coupling mirror 15.

### 1.4.2 First and Second Amplifiers PO1 and PO2

In each of the first and second amplifiers PO1 and PO2, a high voltage pulse generated by the pulse power source 22 is applied to the discharge electrode 21a. A time period from the time when the processor 130 transmits an oscillation trigger signal to the pulse power source 12 to the time when the processor 130 transmits the oscillation trigger signal to the pulse power source 22 is set so as to synchronize a timing at which the seed light B1 enters the inside of the laser chamber 20 and a timing at which the discharge occurs inside the laser chamber 20.

The seed light B1 reciprocates between the rear mirror 24 and the output coupling mirror 25, and is amplified every time it passes through the discharge space inside the laser chamber 20. The amplified laser beam B2 is output through the output coupling mirror 25.

### 1.4.3 First and Second Pulse Stretchers PS1 and PS2

In each of the first and second pulse stretchers PS1 and PS2, the beam splitter 35 transmits a part of the laser beam B2 incoming in the Z direction from the output coupling mirror 25 as first output light in the Z direction, and reflects the other part in the V direction.

The first to fourth concave mirrors 31-34 sequentially reflect the laser beam B2 reflected in the V direction by the beam splitter 35, and make the laser beam B2 enter the beam splitter 35 in the V direction. At the time, a beam cross section of the laser beam B2 that has arrived at the beam splitter 35 in the Z direction is image-formed on the beam splitter 35 in a size of 1:1 by the first to fourth concave mirrors 31-34. The beam splitter 35 reflects a part of the laser beam B2 incoming in the V direction from the fourth concave mirror 34 as second output light in the Z direction, and transmits the other part in the V direction.

Between the first output light and the second output light, there is a time difference corresponding to a time period during which the light travels one cycle in a delay optical path formed by the first to fourth concave mirrors 31-34. By spatially overlapping the first output light and the second output light, the laser beams Bps1 and Bps2 having a stretched pulse width can be output.

By stretching the pulse width of the laser beam, generation of speckles on a surface of the semiconductor wafer exposed by the exposure apparatus 200 is suppressed. The speckles are light and dark spots generated by interference when the laser beam is scattered in order to make a light intensity distribution of the laser beam uniform. Intensity of speckles is expressed by speckle contrast SC and can be calculated by an equation below.

SC=(λ²/(A·Ω)+τ_{C}/TIS)^{1/2}

Here, λ is a wavelength, A is area of the beam cross section, Ω is a beam divergence angle, τ_{C} is coherence time, and TIS is a pulse width calculated by an equation below.

TIS=([∫I(t)dt]²)/(∫I(t)²dt)

Here, t is time and I(t) is light intensity at the time t.

### 1.4.4 Others

The high reflective mirrors 61 and 62 reflect the laser beams Bps1 and Bps2 toward the beam combiner COM, respectively. The beam combiner COM brings optical paths of the laser beams Bps1 and Bps2 close to each other to combine the laser beams Bps1 and Bps2, and outputs combined light.

The processor 130 controls an applied voltage of the first and second oscillators MO1 and MO2 generated by the pulse power source 12 and an applied voltage of the first and second amplifiers PO1 and PO2 generated by the pulse power source 22 so that energy of one pulse of the seed light B1 and energy of one pulse of the laser beam B2 have respective desired values. Further, the processor 130 transmits an oscillation trigger signal to the pulse power sources 12 and 22 so that a repetition frequency of the combined light output from the beam combiner COM becomes a desired value.

In order to improve a processing speed of the semiconductor wafer in the exposure apparatus 200, it is required to increase output energy of the laser apparatus 100. As a method of increasing the output energy of the laser apparatus 100, a method of increasing the repetition frequency and a method of increasing the energy per pulse are conceivable. However, when the repetition frequency is increased, next discharge is sometimes performed before discharge products between the discharge electrodes 11a and l1b and between the discharge electrodes 21a and 21b are removed after discharge of one time, which can make the discharge unstable. Alternatively, when a rotation speed of an unillustrated fan is increased in order to remove discharge products in a short time, power consumption increases. Further, when the repetition frequency is increased, influence of acoustic waves becomes large, which deteriorates light quality. On the other hand, since increase in energy per pulse increases peak intensity, an optical element is easily deteriorated by two-photon absorption.

Therefore, the processor 130 alternately transmits the oscillation trigger signal to the pulse power sources 12 of the first and second oscillators MO1 and MO2. When the repetition frequency of the oscillation trigger signal of each of the first and second oscillators MO1 and MO2 is 6 kHz, the repetition frequency of the combined light can be 12 kHz. As compared with a case where laser oscillation is performed at the repetition frequency of 12 kHz by one oscillator and one amplifier, a possibility of unstable discharge can be reduced according to the configuration of the comparative example since the first and second oscillators MO1 and MO2 and the first and second amplifiers PO1 and PO2 perform the laser oscillation at the repetition frequency of 6 kHz. Further, as compared with a case where the laser oscillation is performed at the repetition frequency of 6 kHz by one oscillator and one amplifier, the deterioration of the optical element is suppressed according to the configuration of the comparative example since the energy of the laser beam per unit time is increased even without increasing the peak intensity of the laser beam.

### 1.5 Problem of Comparative Example

In the comparative example, the first and second oscillators MO1 and MO2 and the first and second amplifiers PO1 and PO2 are required. Since the laser chamber 10 and the line narrowing module 14 are included in each of the first and second oscillators MO1 and MO2, there are problems that the laser apparatus 100 becomes expensive and an installation space becomes large.

### 2. Laser Apparatus 100a that Branches First Amplified Light Bpsa

### 2.1 Configuration

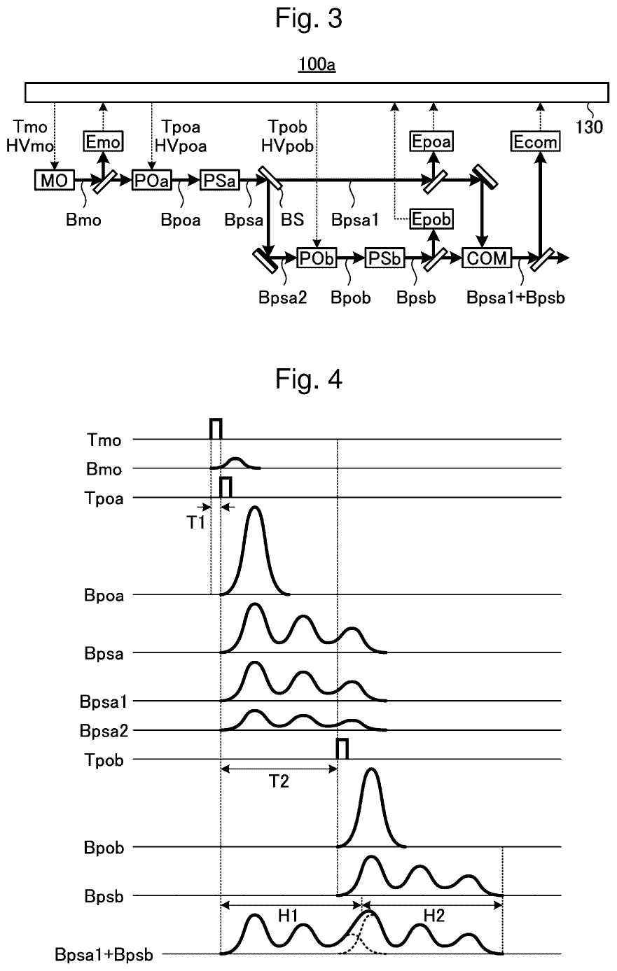

FIG. 3 schematically illustrates a configuration of a laser apparatus 100a according to a first embodiment. The laser apparatus 100a includes an oscillator MO, first and second amplifiers POa and POb, a beam splitter BS, first and second pulse stretchers PSa and PSb, a beam combiner COM, and a processor 130. While FIG. 3 illustrates some high reflective mirrors for changing a traveling direction of light, the traveling direction of the light and disposition of the high reflective mirrors are not limited to those illustrated.

Configurations of the oscillator MO, the first and second amplifiers POa and POb, the first and second pulse stretchers PSa and PSb, the beam combiner COM, and the processor 130 are the same as those of the first oscillator MO1, the first and second amplifiers PO1 and PO2, the first and second pulse stretchers PS1 and PS2, the beam combiner COM, and the processor 130 in the comparative example, respectively.

The oscillator MO outputs seed light Bmo in a pulse form. The first amplifier POa is disposed in an optical path of the seed light Bmo, amplifies the seed light Bmo, and outputs first amplified light Bpoa. The first pulse stretcher PSa is disposed in an optical path of the first amplified light Bpoa, stretches a pulse width of the first amplified light Bpoa, and outputs it as first amplified light Bpsa.

The beam splitter BS is disposed in an optical path of the first amplified light Bpsa having the stretched pulse width, and splits the first amplified light Bpsa into first split light Bpsa1 and second split light Bpsa2. The second split light Bpsa2 has energy smaller than that of the first split light Bpsa1. When the first split light Bpsa1 is light transmitted through the beam splitter BS and the second split light Bpsa2 is light reflected by the beam splitter BS, it is desirable that a transmittance of the beam splitter BS is equal to or higher than 80% and equal to or lower than 96%.

The second amplifier POb is disposed in an optical path of the second split light Bpsa2, amplifies a part of the second split light Bpsa2, and outputs second amplified light Bpob. The second pulse stretcher PSb is disposed in an optical path of the second amplified light Bpob, stretches a pulse width of the second amplified light Bpob, and outputs it as second amplified light Bpsb.

A total optical path length of delay optical paths included in the first pulse stretcher PSa and a total optical path length of delay optical paths included in the second pulse stretcher PSb may be equal to each other. The number of stages of the delay optical paths included in the first pulse stretcher PSa and the number of stages of the delay optical paths included in the second pulse stretcher PSb may be equal to each other. When the first and second pulse stretchers PSa and PSb each include an equal number of stages of delay optical paths, a combination of optical path lengths of the delay optical paths included in the first pulse stretcher PSa and a combination of optical path lengths of the delay optical paths included in the second pulse stretcher PSb may be equal to each other. The optical path lengths of the delay optical paths are considered equal not only when they are completely the same but also when the shorter one is 95% or more of the longer one.

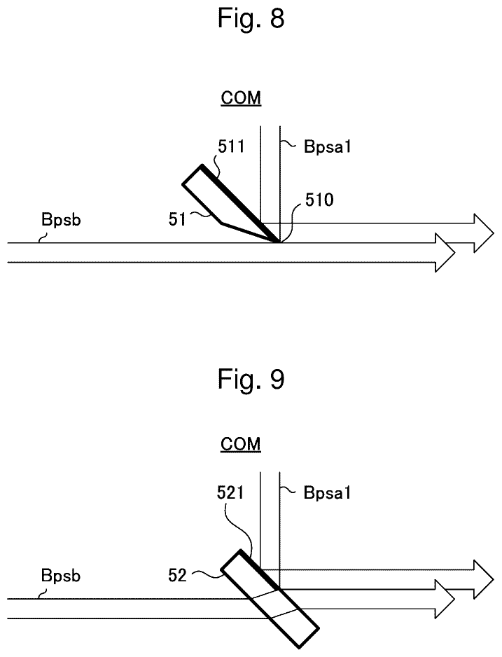

The beam combiner COM is disposed in a space including optical paths of both the first split light Bpsa1 and the second amplified light Bpsb having the stretched pulse width. The beam combiner COM brings the optical paths of the first split light Bpsa1 and the second amplified light Bpsb having the stretched pulse width close to each other to combine the first split light Bpsa1 and the second amplified light Bpsb, and outputs combined light Bpsa1+Bpsb. A configuration of the beam combiner COM will be described later with reference to FIG. 8 and FIG. 9.

A beam splitter having a transmittance higher than a reflectance thereof is disposed in each of the optical paths of the seed light Bmo, the first split light Bpsa1, the second amplified light Bpsb, and the combined light Bpsa1+Bpsb. An energy sensor Emo, a first energy sensor Epoa, a second energy sensor Epob, and an energy sensor Ecom are disposed in the respective optical paths of the light reflected by the beam splitters.

### 2.2 Operation

FIG. 4 is a time chart illustrating pulse time waveforms of the oscillation trigger signal and the laser beam of respective parts of the laser apparatus 100a according to the first embodiment. A horizontal axis in FIG. 4 indicates time, and vertical dashed lines in FIG. 4 indicate that events on the same dashed line occur at substantially the same time.

### 2.2.1 Timing Control

The processor 130 outputs oscillation trigger signals Tmo, Tpoa, and Tpob to the oscillator MO and the first and second amplifiers POa and POb, respectively. The oscillator MO and the first and second amplifiers POa and POb output the seed light Bmo and the first and second amplified light Bpoa and Bpob according to the oscillation trigger signals Tmo, Tpoa, and Tpob, respectively.

A time period T1 from the time when the processor 130 outputs the oscillation trigger signal Tmo to the oscillator MO to the time when the processor 130 outputs the oscillation trigger signal Tpoa to the first amplifier POa is set so as to optimize parameters such as the energy, energy stability, and a spectral linewidth or the like of the first amplified light Bpoa.

A pulse time waveform of the first amplified light Bpsa having the stretched pulse width may include a plurality of peaks. A time interval between adjacent peaks may correspond to a time period during which the light travels one cycle in the delay optical path included in the first pulse stretcher PSa. However, when the first pulse stretcher PSa has a configuration in which a plurality of stages of the delay optical paths are connected in series, combinations of the number of times of one cycle in the delay optical paths vary so that the pulse time waveform of the first amplified light Bpsa becomes a complicated waveform including a larger number of peaks. The same applies to a pulse time waveform of the second amplified light Bpsb having the stretched pulse width.

A ratio of the energy of the first and second split light Bpsa1 and Bpsa2 is determined by the transmittance of the beam splitter BS.

A time period T2 from the time when the processor 130 outputs the oscillation trigger signal Tpoa to the first amplifier POa to the time when the processor 130 outputs the oscillation trigger signal Tpob to the second amplifier POb is set so as to make a pulse width of the combined light Bpsa1+Bpsb as long as possible. From this viewpoint, the processor 130 controls a timing of amplification in the second amplifier POb such that the second amplifier POb amplifies a part included in a second half of a pulse time waveform of the second split light Bpsa2. The time period T2 is longer than the time period T1.

### 2.2.2 Energy Control

The energy of the seed light Bmo is measured by the energy sensor Emo (see FIG. 3). The processor 130 controls an applied voltage HVmo of the oscillator MO based on a measurement result from the energy sensor Emo. In this way, the energy of the seed light Bmo is controlled to be within an appropriate range as the seed light of the first amplifier POa.

Of the second split light Bpsa2 entering the second amplifier POb, only a part after the oscillation trigger signal Tpob is input to the second amplifier POb is used as the seed light of the second amplifier POb. The seed light of the second amplifier POb includes at least one peak portion included in the second half of the pulse time waveform of the second split light Bpsa2. When the energy of the seed light of the second amplifier POb is equal to that of the seed light Bmo of the first amplifier POa, the energy of the second split light Bpsa2 is larger than the energy of the seed light Bmo.

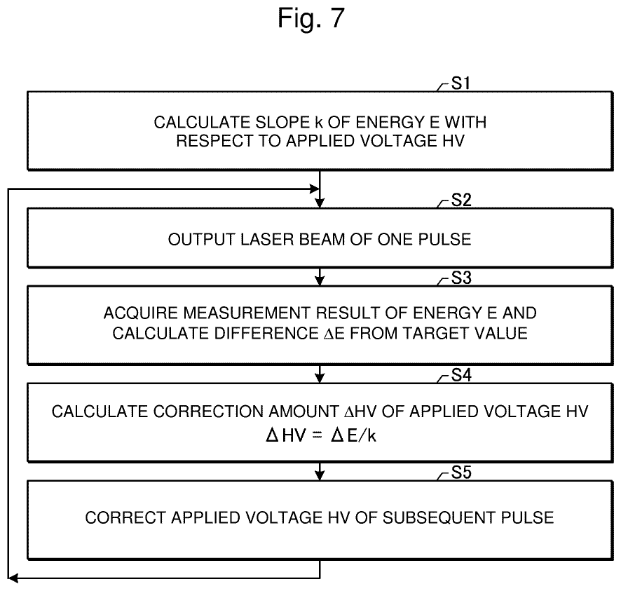

A pulse time waveform of the combined light Bpsa1+Bpsb corresponds to a synthetic waveform of the first split light Bpsa1 and the second amplified light Bpsb, and is controlled as follows. Energy of the first split light Bpsa1 and energy of the second amplified light Bpsb are measured by the first and second energy sensors Epoa and Epob, respectively. The processor 130 controls an applied voltage HVpoa of the first amplifier POa based on a measurement result from the first energy sensor Epoa, and controls an applied voltage HVpob of the second amplifier POb based on a measurement result from the second energy sensor Epob. Control of the applied voltage based on the measurement result of the energy will be described later with reference to FIG. 7.

Alternatively, the pulse time waveform of the combined light Bpsa1+Bpsb may be measured by the energy sensor Ecom. The processor 130 may calculate energy of a first portion included in a first half H1 of the pulse time waveform of the combined light Bpsa1+Bpsb and energy of a second portion included in a second half H2, control the applied voltage HVpoa of the first amplifier POa based on the energy of the first portion, and control the applied voltage HVpob of the second amplifier POb based on the energy of the second portion.

The first split light Bpsa1 and the second amplified light Bpsb may have the same energy. Therefore, a difference in the energy between the first split light Bpsa1 and the second amplified light Bpsb may be smaller than a difference in the energy between the first and second split light Bpsa1 and Bpsa2. Further, since the first split light Bpsa1 is generated by being branched from the first amplified light Bpsa, energy of the first amplified light Bpsa may be larger than the energy of the second amplified light Bpsb.

### 2.3 Effect

(1) According to the first embodiment, the laser apparatus 100a includes the following components.
(a) The oscillator MO configured to output the seed light Bmo in a pulse form,
(b) the first amplifier POa configured to amplify the seed light Bmo and to output the first amplified light Bpoa,
(c) the first pulse stretcher PSa configured to stretch the pulse width of the first amplified light Bpoa,
(d) the beam splitter BS configured to split the first amplified light Bpsa having the stretched pulse width into the first split light Bpsa1 and the second split light Bpsa2 having the energy smaller than that of the first split light Bpsa1,
(e) the second amplifier POb configured to amplify a part of the second split light Bpsa2 and to output the second amplified light Bpob,
(f) the second pulse stretcher PSb configured to stretch the pulse width of the second amplified light Bpob, and
(g) the beam combiner COM configured to combine the first split light Bpsa1 and the second amplified light Bpsb having the stretched pulse width to output the combined light Bpsa1+Bpsb.

When the seed light Bmo output from the oscillator MO is split and made to enter the two amplifiers, output energy of the oscillator MO needs to be doubled in order to make the split seed light Bmo have a light amount required in each of the two amplifiers, and a lifetime of the oscillator MO may be shortened. According to the first embodiment, since the first amplified light Bpsa is split in a stage subsequent to the first amplifier POa, even when just one oscillator MO is used, it is possible to obtain the second split light Bpsa2 having the light amount sufficient as the seed light of the second amplifier POb while suppressing a load of the oscillator MO. Since one oscillator MO, one laser chamber 10, and one line narrowing module 14 are used, it is possible to suppress the laser apparatus 100a from becoming expensive and an installation space from becoming large. Further, since the first amplified light Bpsa is split in a stage subsequent to the first pulse stretcher PSa, it is possible to reduce the peak intensity of the first amplified light Bpsa entering the beam splitter BS and to suppress the deterioration of an optical element such as the beam splitter BS.

(2) According to the first embodiment, the laser apparatus 100a further includes the processor 130. The processor 130 controls the timing of the amplification in the second amplifier POb such that the second amplifier POb amplifies the part included in the second half of the pulse time waveform of the second split light Bpsa2.

Accordingly, since the second amplified light Bpsb is obtained by amplifying a part of the second split light Bpsa2 included in the second half of the pulse time waveform of the second split light Bpsa2, it is possible to increase the pulse width of the combined light Bpsa1+Bpsb when the first split light Bpsa1 and the second amplified light Bpsb are combined. Then, the speckle contrast SC can be reduced by increasing the pulse width.

(3) According to the first embodiment, the difference in the energy between the first split light Bpsa1 and the second amplified light Bpsb having the stretched pulse width is smaller than the difference in the energy between the first and second split light Bpsa1 and Bpsa2.

Accordingly, it is possible to reduce the difference in the energy between the first and second halves of the combined light Bpsa1+Bpsb.

(4) According to the first embodiment, the laser apparatus 100a includes the processor 130. The processor 130 is configured to output the oscillation trigger signals Tmo, Tpoa, and Tpob to the oscillator MO, the first amplifier POa, and the second amplifier POb, respectively. The time period T1 from the time of outputting the oscillation trigger signal Tmo to the oscillator MO to the time of outputting the oscillation trigger signal Tpoa to the first amplifier POa is shorter than the time period T2 from the time of outputting the oscillation trigger signal Tpoa to the first amplifier POa to the time of outputting the oscillation trigger signal Tpob to the second amplifier POb.

Accordingly, by shifting the timings of the amplification in the first and second amplifiers POa and POb, it is possible to increase the pulse width of the combined light Bpsa1+Bpsb when the first split light Bpsa1 and the second amplified light Bpsb are combined.

(5) According to the first embodiment, the energy of the second split light Bpsa2 is larger than the energy of the seed light Bmo.

Accordingly, since the energy of the second split light Bpsa2 is large, a part of the second split light Bpsa2 can be made to have the light amount sufficient as the seed light of the second amplifier POb.

(6) According to the first embodiment, the laser apparatus 100a includes the first energy sensor Epoa configured to measure the energy of the first split light Bpsa1, the second energy sensor Epob configured to measure the energy of the second amplified light Bpsb having the stretched pulse width, and the processor 130. The processor 130 controls the applied voltage HVpoa of the first amplifier POa based on the measurement result from the first energy sensor Epoa, and controls the applied voltage HVpob of the second amplifier POb based on the measurement result from the second energy sensor Epob.

Accordingly, by separately measuring the first split light Bpsa1 and the second amplified light Bpsb and independently controlling the applied voltages HVpoa and HVpob of the first and second amplifiers POa and POb, the pulse time waveform of the combined light Bpsa1+Bpsb can be controlled with high accuracy, and sufficient energy stability can be achieved. Further, a dose amount indicating the energy of the laser beam with which one portion of the semiconductor wafer is irradiated can also be stabilized.

(7) According to the first embodiment, the laser apparatus 100a includes the energy sensor Ecom configured to measure the pulse time waveform of the combined light Bpsa1+Bpsb, and the processor 130. The processor 130 calculates the energy of the first portion included in the first half H1 of the pulse time waveform and the energy of the second portion included in the second half H2 of the pulse time waveform, controls the applied voltage HVpoa of the first amplifier POa based on the energy of the first portion, and controls the applied voltage HVpob of the second amplifier POb based on the energy of the second portion.

Accordingly, it is possible to obtain information required to independently control the applied voltages HVpoa and HVpob of the first and second amplifiers POa and POb in one energy sensor Ecom. Thus, the pulse time waveform of the combined light Bpsa1+Bpsb can be controlled with high accuracy, and the sufficient energy stability can be achieved. The dose amount can be also stabilized.

(8) According to the first embodiment, the energy of the first amplified light Bpsa having the stretched pulse width is larger than the energy of the second amplified light Bpsb having the stretched pulse width.

Accordingly, since the energy of the first amplified light Bpsa is large, the first split light Bpsa1 obtained by splitting the first amplified light Bpsa can be made to have the light amount sufficient as a part of the combined light Bpsa1+Bpsb.

(9) According to the first embodiment, the first split light Bpsa1 is light transmitted through the beam splitter BS, the second split light Bpsa2 is light reflected by the beam splitter BS, and the transmittance of the beam splitter BS is equal to or higher than 80% and equal to or lower than 96%.

Accordingly, it is possible to make the first split light Bpsa1 have the light amount sufficient as a part of the combined light Bpsa1+Bpsb, and to make a part of the second split light Bpsa2 have the light amount sufficient as the seed light of the second amplifier POb.

(10) According to the first embodiment, the optical path lengths of the delay optical paths included in the first and second pulse stretchers PSa and PSb are equal to each other.

Accordingly, pulse time widths of the first split light Bpsa1 and the second amplified light Bpsb can be made equal.

(11) According to the first embodiment, the first and second pulse stretchers PSa and PSb each include an equal number of stages of the delay optical paths, the equal number being two or more.

Accordingly, the speckle contrasts SC of the first split light Bpsa1 and the second amplified light Bpsb can be made equal to each other.

(12) According to the first embodiment, the combination of the optical path lengths of the delay optical paths included in the first pulse stretcher PSa is equal to the combination of the optical path lengths of the delay optical paths included in the second pulse stretcher PSb.

Accordingly, the pulse time widths and the speckle contrasts SC of the first split light Bpsa1 and the second amplified light Bpsb can be made equal to each other.

(13) According to the first embodiment, the beam combiner COM brings the optical paths of the first split light Bpsa1 and the second amplified light Bpsb having the stretched pulse width close to each other to combine the first split light Bpsa1 and the second amplified light Bpsb, and outputs the combined light Bpsa1+Bpsb.

Accordingly, the combined light Bpsa1+Bpsb can be generated even when wavelengths and polarization directions of the first split light Bpsa1 and the second amplified light Bpsb are the same.

In other respects, the first embodiment is similar to the comparative example.

### 3. Laser Apparatus 100b that Stretches Pulse Width of Combined Light Bpsa1+Bpsb

### 3.1 Configuration

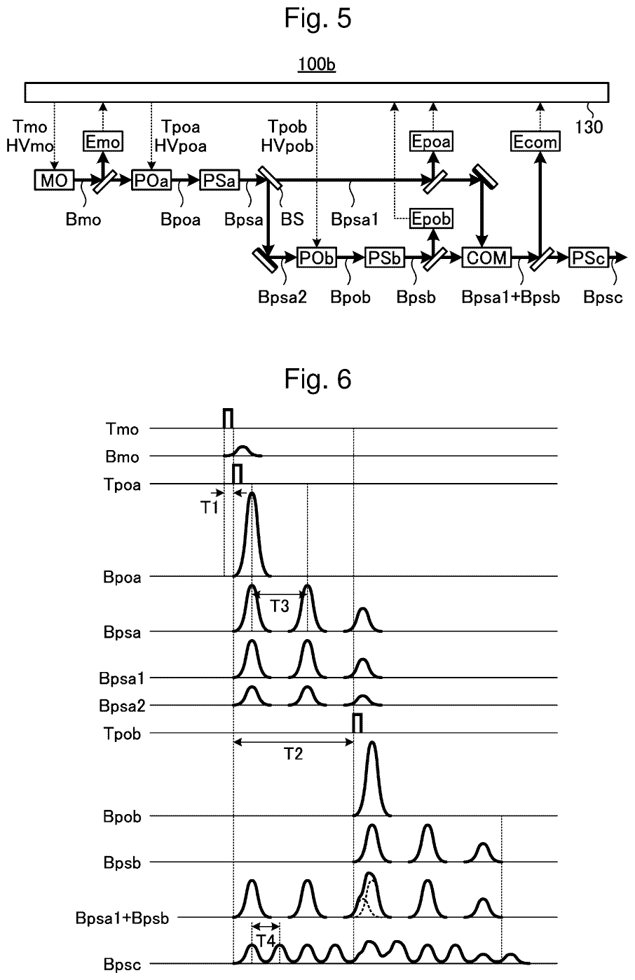

FIG. 5 schematically illustrates a configuration of a laser apparatus 100b according to a second embodiment. The laser apparatus 100b includes a third pulse stretcher PSc disposed in an optical path of the combined light Bpsa1+Bpsb. The third pulse stretcher PSc stretches the pulse width of the combined light Bpsa1+Bpsb and outputs it as combined light Bpsc.

Since the third pulse stretcher PSc is added in the second embodiment, the number of stages of the delay optical paths of the first and second pulse stretchers PSa and PSb is desirably as small as possible with one as a lower limit. In a case where the number of stages of the delay optical paths additionally required in addition to the delay optical paths of the first and second pulse stretchers PSa and PSb is included in the third pulse stretcher PSc, the number of the delay optical paths included in the laser apparatus 100b can be reduced. Therefore, the number of stages of the delay optical paths included in each of the first and second pulse stretchers PSa and PSb is desirably equal to or smaller than the number of stages of the delay optical paths included in the third pulse stretcher PSc. In addition, the numbers of stages of the delay optical paths included in the first and second pulse stretchers PSa and PSb are desirably equal to each other. Further, a difference in the optical path lengths between the first and second pulse stretchers PSa and PSb is desirably smaller than both the difference in the optical path lengths between the first and third pulse stretchers PSa and PSc and the difference in the optical path lengths between the second and third pulse stretchers PSb and PSc.

The optical path length of each of the first and second pulse stretchers PSa and PSb is desirably longer than the optical path length of the delay optical paths included in the third pulse stretcher PSc. When the third pulse stretcher PSc includes a plurality of stages of the delay optical paths, the optical path length of each of the first and second pulse stretchers PSa and PSb is desirably longer than the optical path length of the delay optical path that is the longest of the delay optical paths included in the third pulse stretcher PSc.

### 3.2 Operation

FIG. 6 is a time chart illustrating pulse time waveforms of an oscillation trigger signal and a laser beam of respective parts of the laser apparatus 100b according to the second embodiment. Since the optical path length of the first pulse stretcher PSa is longer than the optical path length of the third pulse stretcher PSc, a time period T3 during which the first amplified light Bpoa travels one cycle in the delay optical path included in the first pulse stretcher PSa is longer than a time period T4 during which the combined light Bpsa1+Bpsb travels one cycle in the delay optical path included in the third pulse stretcher PSc.

Since the optical path length of each of the first and second pulse stretchers PSa and PSb is long, the time period T2 from the time when the processor 130 outputs the oscillation trigger signal Tpoa to the first amplifier POa to the time when the processor 130 outputs the oscillation trigger signal Tpob to the second amplifier POb can be long. The time period T2 is desirably longer than the time period T3.

### 3.3 Effect

(14) According to the second embodiment, the laser apparatus 100b further includes, in addition to the components of the laser apparatus 100a, the third pulse stretcher PSc configured to stretch the pulse width of the combined light Bpsa1+Bpsb.

Accordingly, instead of adding the third pulse stretcher PSc, the optical path length and the number of stages of each of the first and second pulse stretchers PSa and PSb can be reduced. Thus, the total optical path length and the total number of stages of the first, second, and third pulse stretchers PSa, PSb, and PSc can be reduced.

(15) According to the second embodiment, each of the first and second pulse stretchers PSa and PSb includes the number of stages of the delay optical paths equal to or smaller than the number of stages of the delay optical paths included in the third pulse stretcher PSc.

Accordingly, since the number of stages of the delay optical paths of each of the first and second pulse stretchers PSa and PSb is further reduced, the total number of stages of the delay optical paths of the first, second, and third pulse stretchers PSa, PSb and PSc can be reduced.

(16) According to the second embodiment, the first and second pulse stretchers PSa and PSb each include an equal number of stages of the delay optical paths.

Accordingly, the speckle contrasts SC of the first split light Bpsa1 and the second amplified light Bpsb can be made equal to each other.

(17) According to the second embodiment, the difference in the optical path lengths between the first and second pulse stretchers PSa and PSb is smaller than both the difference in the optical path lengths between the first and third pulse stretchers PSa and PSc and the difference in the optical path lengths between the second and third pulse stretchers PSb and PSc.

It is conceivable that a configuration of the first pulse stretcher PSa suitable for a combination with the third pulse stretcher PSc is also suitable as a configuration of the second pulse stretcher PSb. By reducing the difference in the optical path lengths between the first and second pulse stretchers PSa and PSb, the pulse time waveforms of both the first split light Bpsa1 and the second amplified light Bpsb having the stretched pulse width can be optimized.

(18) According to the second embodiment, each of the optical path length of the first pulse stretcher PSa and the optical path length of the second pulse stretcher PSb is longer than the optical path length of the third pulse stretcher PSc.

Accordingly, a time difference between the first split light Bpsa1 and the second amplified light Bpsb can be increased, and the pulse width of the combined light Bpsa1+Bpsb can be increased.

(19) According to the second embodiment, the laser apparatus 100b includes the processor 130. The processor 130 is configured to output the oscillation trigger signals Tpoa and Tpob to the first and second amplifiers POa and POb, respectively. The time period T2 from the time of outputting the oscillation trigger signal Tpoa to the first amplifier POa to the time of outputting the oscillation trigger signal Tpob to the second amplifier POb is longer than the time period T3 during which the first amplified light Bpoa travels one cycle in the delay optical path included in the first pulse stretcher PSa.

Accordingly, by largely shifting the timings of the amplification in the first and second amplifiers POa and POb, it is possible to increase the pulse width of the combined light Bpsa1+Bpsb when the first split light Bpsa1 and the second amplified light Bpsb are combined.

In other respects, the second embodiment is similar to the first embodiment.

### 4. Others

### 4.1 Control of Applied Voltage

FIG. 7 is a flowchart of the control of the applied voltage executed by the processor 130 in the first and second embodiments. In FIG. 7, the following five kinds of the control will be collectively described as the control of an applied voltage HV based on energy E of the laser beam.
(a) Control of the applied voltage HVmo of the oscillator MO based on the energy of the seed light Bmo measured by the energy sensor Emo
(b) Control of the applied voltage HVpoa of the first amplifier Poa based on the energy of the first split light Bpsa1 measured by the first energy sensor Epoa
(c) Control of the applied voltage HVpob of the second amplifier POb based on the energy of the second amplified light Bpob measured by the second energy sensor Epob
(d) Control of the applied voltage HVpoa of the first amplifier POa based on the energy of the first portion of the combined light Bpsa1+Bpsb measured by the energy sensor Ecom
(e) Control of the applied voltage HVpob of the second amplifier POb based on the energy of the second portion of the combined light Bpsa1+Bpsb measured by the energy sensor Ecom

In S1, the processor 130 acquires a result of measuring the energy E of the laser beam while changing the applied voltage HV, and calculates a slope k of the energy E with respect to the applied voltage HV. This calculation is performed at regular intervals.

In S2, the processor 130 outputs an oscillation trigger signal to cause the laser beam of one pulse to be output.

In S3, the processor 130 acquires a measurement result of the energy E of the laser beam, and calculates a difference ΔE from a target value.

In S4, the processor 130 calculates a correction amount ΔHV of the applied voltage HV by an equation below.

ΔHV=ΔE/k

In S5, the processor 130 corrects the applied voltage HV of the subsequent pulse using the correction amount ΔHV.

After S5, the processor 130 returns processing to S2. As described above, the applied voltage HV is controlled so that the energy E of the laser beam approaches the target value.

### 4.2 Configuration of Beam Combiner COM

FIG. 8 illustrates a first configuration example of the beam combiner COM used in the first and second embodiments. The beam combiner COM according to the first configuration example includes a prism mirror 51 coated with a high reflective film 511.

The first split light Bpsa1 and the second amplified light Bpsb enter the beam combiner COM through the optical paths perpendicular to each other. A high reflective surface coated with the high reflective film 511 is inclined by 45 degrees with respect to each of the first split light Bpsa1 and the second amplified light Bpsb. The high reflective surface and another surface of the prism mirror 51 form a ridge line 510 at an angle of 45 degrees or lower. The second amplified light Bpsb does not enter the prism mirror 51, and passes through a position as close as possible to the ridge line 510 of the prism mirror 51. The first split light Bpsa1 is incident on the high reflective surface at a position as close as possible to the ridge line 510, and is reflected in a direction parallel to the second amplified light Bpsb. Thus, the first split light Bpsa1 and the second amplified light Bpsb can be brought close to each other.

FIG. 9 illustrates a second configuration example of the beam combiner COM used in the first and second embodiments. The beam combiner COM according to the second configuration example has a configuration in which a part of a planar substrate 52 transparent to the second amplified light Bpsb is coated with a high reflective film 521 and the other part is coated with a reflection suppressing film.

The first split light Bpsa1 and the second amplified light Bpsb enter the planar substrate 52 through optical paths perpendicular to each other. A high reflective surface coated with the high reflective film 521 is inclined by 45 degrees with respect to each of the first split light Bpsa1 and the second amplified light Bpsb. The second amplified light Bpsb is transmitted through a part coated with the reflection suppressing film at a position as close as possible to a boundary with the part coated with the high reflective film 521. The first split light Bpsa1 is incident on a part coated with the high reflective film 521 at a position as close as possible to a boundary with the part coated with the reflection suppressing film, and is reflected in a direction parallel to the second amplified light Bpsb. Thus, the first split light Bpsa1 and the second amplified light Bpsb can be brought close to each other.

### 4.3 Supplements

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser apparatus comprising:
an oscillator configured to output seed light in a pulse form;
a first amplifier configured to amplify the seed light and to output first amplified light;
a first pulse stretcher configured to stretch a pulse width of the first amplified light;
a beam splitter configured to split the first amplified light having a stretched pulse width into first split light and second split light having energy smaller than energy of the first split light;
a second amplifier configured to amplify a part of the second split light and to output second amplified light;
a second pulse stretcher configured to stretch a pulse width of the second amplified light; and
a beam combiner configured to combine the first split light and the second amplified light having a stretched pulse width to output combined light.

2. The laser apparatus according to claim 1, further comprising
a processor, wherein
the processor controls a timing of amplification in the second amplifier such that the second amplifier amplifies the part included in a second half of a pulse time waveform of the second split light.

3. The laser apparatus according to claim 2, wherein
a difference in energy between the first split light and the second amplified light having the stretched pulse width is smaller than a difference in energy between the first split light and the second split light.

4. The laser apparatus according to claim 1, further comprising
a processor, wherein
the processor is configured to output respective oscillation trigger signals to the oscillator and the first and second amplifiers, and a time period from time of outputting the oscillation trigger signal to the oscillator to time of outputting the oscillation trigger signal to the first amplifier is shorter than a time period from time of outputting the oscillation trigger signal to the first amplifier to time of outputting the oscillation trigger signal to the second amplifier.

5. The laser apparatus according to claim 1, wherein
energy of the second split light is larger than energy of the seed light.

6. The laser apparatus according to claim 1, further comprising:
a first energy sensor configured to measure energy of the first split light;
a second energy sensor configured to measure energy of the second amplified light having the stretched pulse width; and
a processor, wherein
the processor controls an applied voltage of the first amplifier based on a measurement result from the first energy sensor, and controls an applied voltage of the second amplifier based on a measurement result from the second energy sensor.

7. The laser apparatus according to claim 1, further comprising:
an energy sensor configured to measure a pulse time waveform of the combined light; and
a processor, wherein
the processor calculates energy of a first portion included in a first half of the pulse time waveform and energy of a second portion included in a second half of the pulse time waveform, controls an applied voltage of the first amplifier based on the energy of the first portion, and controls an applied voltage of the second amplifier based on the energy of the second portion.

8. The laser apparatus according to claim 1, wherein
energy of the first amplified light having the stretched pulse width is larger than energy of the second amplified light having the stretched pulse width.

9. The laser apparatus according to claim 1, wherein
the first split light is light transmitted through the beam splitter,
the second split light is light reflected by the beam splitter, and
a transmittance of the beam splitter is equal to or higher than 80% and equal to or lower than 96%.

10. The laser apparatus according to claim 1, wherein
optical path lengths of delay optical paths included in the first and second pulse stretchers are equal to each other.

11. The laser apparatus according to claim 1, wherein
the first and second pulse stretchers each include an equal number of stages of the delay optical paths, the equal number being two or more.

12. The laser apparatus according to claim 11, wherein
a combination of optical path lengths of the delay optical paths included in the first pulse stretcher is equal to a combination of optical path lengths of the delay optical paths included in the second pulse stretcher.

13. The laser apparatus according to claim 1, wherein
the beam combiner brings optical paths of the first split light and the second amplified light having the stretched pulse width close to each other to combine the first split light and the second amplified light, and outputs the combined light.

14. The laser apparatus according to claim 1, further comprising
a third pulse stretcher configured to stretch a pulse width of the combined light.

15. The laser apparatus according to claim 14, wherein
each of the first and second pulse stretchers includes a number of stages of delay optical paths equal to or smaller than a number of stages of delay optical paths included in the third pulse stretcher.

16. The laser apparatus according to claim 15, wherein
the first and second pulse stretchers each include an equal number of stages of the delay optical paths.

17. The laser apparatus according to claim 14, wherein
a difference in optical path lengths between the first and second pulse stretchers is smaller than both a difference in optical path lengths between the first and third pulse stretchers and a difference in optical path lengths between the second and third pulse stretchers.

18. The laser apparatus according to claim 14, wherein
each of an optical path length of the first pulse stretcher and an optical path length of the second pulse stretcher is longer than an optical path length of the third pulse stretcher.

19. The laser apparatus according to claim 14, further comprising
a processor, wherein
the processor is configured to output respective oscillation trigger signals to the first and second amplifiers, and a time period from time of outputting the oscillation trigger signal to the first amplifier to time of outputting the oscillation trigger signal to the second amplifier is longer than a time period during which the first amplified light travels one cycle in a delay optical path included in the first pulse stretcher.

20. An electronic device manufacturing method comprising:
generating a laser beam with a laser apparatus, the laser apparatus including
an oscillator configured to output seed light in a pulse form,
a first amplifier configured to amplify the seed light and to output first amplified light,
a first pulse stretcher configured to stretch a pulse width of the first amplified light,
a beam splitter configured to split the first amplified light having a stretched pulse width into first split light and second split light having energy smaller energy that of the first split light,
a second amplifier configured to amplify a part of the second split light and to output second amplified light,
a second pulse stretcher configured to stretch a pulse width of the second amplified light, and
a beam combiner configured to combine the first split light and the second amplified light having a stretched pulse width to output combined light;
outputting the laser beam to an exposure apparatus; and
exposing a photosensitive substrate to the laser beam within the exposure apparatus to manufacture an electronic device.
